(19) United States
(12) Patent Application Publication
(10) Pub. No.: US 2016/0146406 A1
(43) Pub. Date: May 26, 2016

(54) LED Tennis Court Fixture

(71) Applicant: Neptun Light, Inc., Lake Forest, IL (US)

(72) Inventor: Andzrej Bobel, Lake Forest, IL (US)

(21) Appl. No.: 14/552,201

(22) Filed: Nov. 24, 2014

(51) Int. Cl. F21K 99/00; F21V 29/70; F21V 5/04

(52) U.S. Cl. CPC F21K 9/50; F21V 5/04; F21V 29/70; F21Y 2101/02

(57) ABSTRACT

An indirect LED light fixture for illuminating tennis courts and other indoor facilities is disclosed. The light fixture is highly efficient and provides for even distribution of light. The fixture employs at least one LED (Light Emitting Diode) light source equipped with at least one optical lens having a predefined light output beam pattern. Light emitted by the LED is controlled and directed to a ceiling or a wall by a lens to achieve highly uniform illumination of the surface area desired to be illuminated. The beam angle of the light emitted by the LED light source may be adjustable by adjustment of the position of the lens in relation to the light emitting side of the LED light source. The light fixture has minimal reflection losses, a wide adjustment range of light output, and a high color rendering index.

### BACKGROUND

1. Field of the Invention

This invention relates to indirect lighting fixtures and more particularly to LED indirect fixtures for illuminating indoor tennis courts and other indoor facilities.

2. Description of the Related Art

Indirect lighting fixtures are well known wherein the fixtures are aimed or positioned such that the light source or lamp is not directly visible and light is dispersed by directing it at a ceiling or wall. These fixtures, however, generally include a plurality of drawbacks and have not been adequately efficient to effectively replace direct lighting even though indirect lighting is preferable in many applications. Indirect lighting fixtures have proved to be inefficient in part because they have failed to provide convenient and effective means to evenly disperse the light emitted by the lamps. For example, the intensity of the light emitted by the lamps and directed against a reflecting surface such as a ceiling or wall is often concentrated at a single point or in a plurality of definite areas rather than uniformly distributed across the area illuminated. Due to this uneven distribution of the light intensity striking the reflecting surface, the efficacy of conventional indirect light fixtures is relatively low and they are unduly wasteful of energy. Information relevant to attempts to address these problems can be found in U.S. Pat. No. 4,056,667 (which is not admitted to be prior art with respect to the present invention by its mention in this Background Section), where the inventors employed use of 1000 Watt HID (high intensity discharge) light sources positioned horizontally inside a complex reflector structure. Such indirect fixtures that use HID light sources employ relatively large reflectors in an attempt to attain a more even distribution of light. Such fixtures suffer from one or more of the following disadvantages: the high-energy HID light source makes the products still very inefficient in regards to energy use; the reflectors used, by their nature, make the light fixture very inefficient optically due to high reflection losses inside the fixture which can be as high as 30%; the lamp positioning in relation to complex reflector :structure results in a very narrow adjustment range of the illumination angle of light output of the fixture which makes the light fixtures not widely and easy adaptable to all types of indoor tennis courts and other facilities; and HID light sources are well known to have a very low color rendering index of 62, which is too low for modern indoor tennis courts or other indoor facilities whose requirements are 80 and above.

Additionally, indirect light fixtures for illuminating tennis courts must provide good visibility for both players and spectators, creating sufficient contrast between objects and their backgrounds, and allowing both players and spectators to see the ball clearly. This requires good illumination levels, even light distribution across the playing surface, and minimal glare.

Some National Associations and governments have set different requirements for indoor lighting and may use different units of measurement. However, as a guide, the following table shows the minimum standards according to the European Standard for Sports Lighting, EN 12193:2008, where Class I events include top-level national and international competitions (non-televised) with requirements for spectators with potentially long viewing distances, Class II events include mid-level competitions such as regional or local club tournaments (medium-sized numbers of spectators with average viewing distances; high-level training may also be included in this class), and Class III events include low-level competition, such as local or small club tournaments (this does not usually involve spectators; general training, school sports and recreational activities also fall into this class).

Lighting specifications for indoor courts

| | | Uniformity | | | Lamp |
|---|---|---|---|---|---|
| | Horizontal | of | | Lamp | Color |
| | illumination | Illumination | | Color | Rendering |
| | Eₕ average | E_{h min}/ | Glare | Temperature | Index |
| | (Lux) | Eₕ ave | GR | (Kelvin) | CRI |
| Class I | >750 | >0.7 | <50 | >4000 | >80 |
| Class II | >500 | >0.7 | <50 | >4000 | >65 |
| Class III | >300 | >0.5 | <55 | >2000 | >20 |

As shown above, minimum standards for indoor tennis court lighting require adequate levels of horizontal illumination (the amount of light falling on the court surface in unit measure of Lux), uniformity of illumination (parameter describing how evenly light is distributed over the court surface), glare (the disturbing effect which impairs vision which depends mainly on the ratio between the direct brightness of a lighting installation and the brightness of the court surface), color temperature (the apparent color of a light of the source in Kelvin degrees), and color rendering index (the ability of a light source to reveal and reproduce colors accurately, the highest index is 100).

These standards and considerations create a great need for an indirect fixture for illuminating tennis courts that both meets or exceeds all required parameters and is energy efficient. Indirect light fixtures for illuminating tennis courts and other indoor facilities fail to meet adequate lighting parameters in an energy-efficient manner and come with several drawbacks.

Other disadvantages of related indirect light fixtures, in addition to those mentioned above, include several problems related to different types of light sources, each with their own disadvantages. HID sources have high replacement cost and require ten to fifteen minutes of warm up time in order to reach full light output, as well as require the same time to re-start after each power interruption. High-pressure sodium (HPS) sources have poor color rendering and also take ten to fifteen minutes to reach full light output. Fluorescent sources are inefficient at low temperatures, require deflectors to enable light to diffuse in the correct direction, and are noisy and distracting to players and spectators. Tungsten halogen sources have short lifetimes, low efficiency, and high maintenance and operating costs. A need exists for an indirect tennis court light source that minimizes or eliminates these problems.

### SUMMARY OF THE INVENTION

The present invention provides an improved LED indirect light fixture for use in indirect lighting of indoor facilities which is highly efficient and which provides for even distribution of light upon a relatively large area of the surface to be illuminated.

The light fixture of the present invention employs at least one LED (Light Emitting Diode) light source equipped with at least one optical lens having a predefined light output beam pattern.

In the fixture of the present invention, the light emitted by the LED is controlled and directed to a ceiling or a wall by a lens in a specific way to achieve highly uniform illumination of the surface area desired to be illuminated.

The light fixture of the present invention is comprised of a housing which supports at least one lens, at least one LED light source, and at least one heat sink unit, all arranged to fit into a fixture enclosure. Optionally, the fixture enclosure may function as a heat sink unit.

In the fixture of the present invention, the beam angle of the light emitted by the LED light source may be adjustable by adjustment of the position of the lens in relation to the light emitting side of the LED light source.

Furthermore, the LED indirect lighting fixture of the present invention comprises: an enclosure having an opening defined by an edge rim along a perimeter of said opening; a LED light source having a light emitting side and a base side; a light engine having a light engine plate fitted into the edge rim; at least one integrated LED-lens module comprised of a transparent lens fitted over the light emitting side of the LED light source and a heat sink thermally coupled to the base side of the LED light source; at least one LED-lens module fitted in the opening of the enclosure; wherein light emitted from the LED-lens module is emitted directly outward from the opening of the enclosure.

Furthermore, another embodiment of the LED indirect lighting fixture of the present invention comprises: an enclosure having an opening defined by an edge rim along a perimeter of said opening; a LED light source having a light emitting side and a base side; a light engine having a light engine plate fitted into the edge rim; at least one integrated LED-lens module comprised of a transparent lens fitted over the light emitting side of the LED light source and a heat sink thermally coupled to the base side of the LED light source; at least one LED-lens module fitted in the opening of the enclosure; whereby the enclosure performs the function of a heat sink; and wherein light emitted from the LED-lens module is emitted directly outward from the opening of the enclosure.

Furthermore, another embodiment of the LED indirect lighting fixture of the present invention comprises: an enclosure having an opening defined by an edge rim along a perimeter of said opening; a LED light source having a light emitting side and a base side; a light engine having a light engine plate fitted into the edge rim; at least one integrated LED-lens module comprised of a transparent lens fitted over the light emitting side of the LED light source and a heat sink thermally coupled to the base side of the LED light source; at least one LED-lens module fitted in the opening of the enclosure; wherein light emitted from the LED-lens module is emitted directly outward from the opening of the enclosure with an adjustable beam angle; wherein the position of at least one lens of a LED-lens module is adjustable relative to the light emitting side of a LED light source; and wherein the adjustable beam angle is a result of the adjustable position of at least one lens of the LED-lens module in relation to the position of the light emitting side of the LED light source.

In each embodiment of the invention, the lens is made of transparent glass or plastic material.

Thus, an indirect LED lighting fixture in accordance with the present invention provides numerous advantages over conventionally used indirect lighting fixtures.

### BRIEF DESCRIPTION OF THE DRAWINGS

FIG. 1 is a side view of a LED indirect light fixture in accordance with one embodiment of the invention;

FIG. 2a is a cross-sectional view of the LED indirect light fixture shown in FIG. 1;

FIG. 2b is an enlarged view of a portion of the LED indirect light fixture shown in FIG. 1;

FIG. 3 is a bottom exploded view of the LED indirect light fixture shown in FIG. 1;

FIG. 4 is a top side view of the LED indirect light fixture shown in FIG. 1;

FIG. 5 is a bottom perspective view of the LED indirect light fixture shown in FIG. 1;

FIG. 6 is a bottom side view of the LED indirect light fixture shown in FIG. 1;

FIG. 7 is a right side view of the LED indirect light fixture in accordance with another embodiment of the invention;

FIG. 8 is a top perspective view of the LED indirect light fixture in accordance with another embodiment of the invention;

FIG. 9 is a top perspective view of the LED direct light fixture in accordance with another embodiment of the invention;

FIG. 10 is a top side view of a light engine plate of the LED indirect light fixture in accordance with another embodiment of the invention;

FIG. 11 is a top side view of a light engine plate of the LED indirect light fixture in accordance with another embodiment of the invention;

FIG. 12 is a top side view of a light engine plate of the LED indirect light fixture in accordance with another embodiment of the invention;

FIG. 13 is a top side view of a light engine plate of the LED indirect light fixture in accordance with another embodiment of the invention;

FIG. 14 is a top side view of a light engine plate of the LED indirect light fixture in accordance with another embodiment of the invention;

FIG. 15 is a cross-sectional front side view of an adjustable beam angle light engine of a LED indirect light fixture in accordance with all embodiments of the invention;

FIG. 16 is a right side view of an asymmetrical beam pattern of one embodiment of the invention;

FIG. 17 is a front side view of a symmetrical beam pattern of one embodiment of the invention;

FIG. 18 is a front side view of a beam pattern output angle of one embodiment of the invention;

FIG. 19 is a front side view of a beam pattern output angle of another embodiment of the invention;

FIG. 20 is a front side view of a beam pattern output angle of another embodiment of the invention;

FIG. 21 is a front side view of a beam pattern output angle of another embodiment of the invention;

FIG. 22 is a front side view of a beam pattern output angle of another embodiment of the invention;

FIG. 23 is an exploded cross-sectional front side view of a non-adjustable beam angle light engine of a LED indirect light fixture in accordance with all embodiments of the invention;

FIG. 24 is a cross-sectional front side view of a non-adjustable beam angle light engine of a LED indirect light fixture in accordance with all embodiments of the invention;

FIG. 25 is a top perspective view of a non-adjustable beam angle light engine of a

LED indirect light fixture in accordance with all embodiments of the invention.

### DETAILED DESCRIPTION

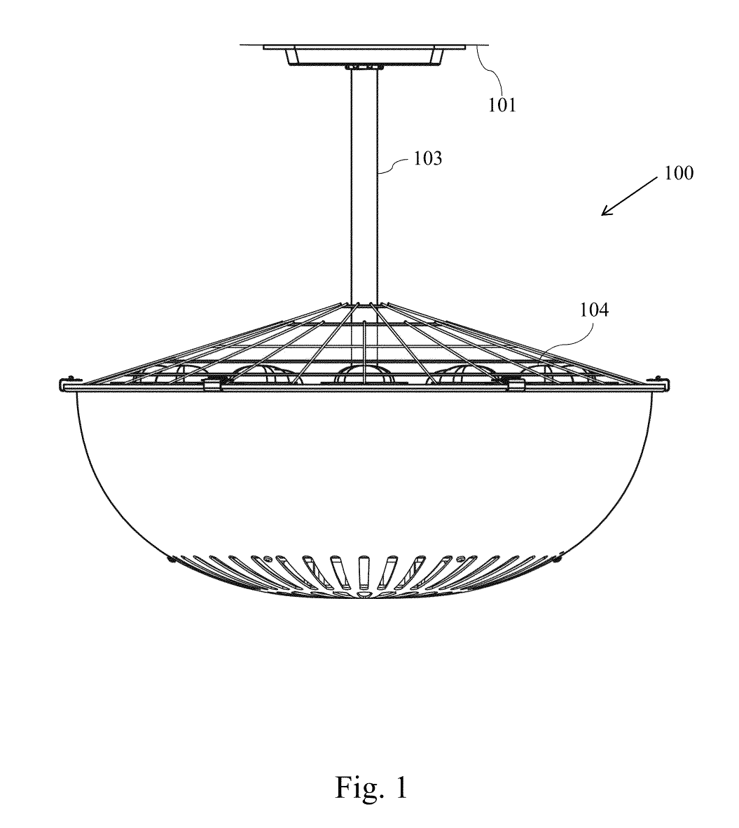

Referring now to the drawings, FIG. 1 shows a side view of a LED indirect light fixture 100 in accordance with a preferred embodiment of the invention suitable for use in lighting of indoor tennis courts or other facilities. The fixture 100 has a power input of approximately 500 watts and produces 66,740 lumens of light output, directed at a ceiling 101. The fixture 100 is attached to the ceiling 101 by a stem 103. The fixture 100 uses LED light sources having efficacies of approximately 142 Lumens per Watt. Thus, a total fixture efficiency of 94% is achieved, which is equal to the light transmission efficiency of a lens 104.

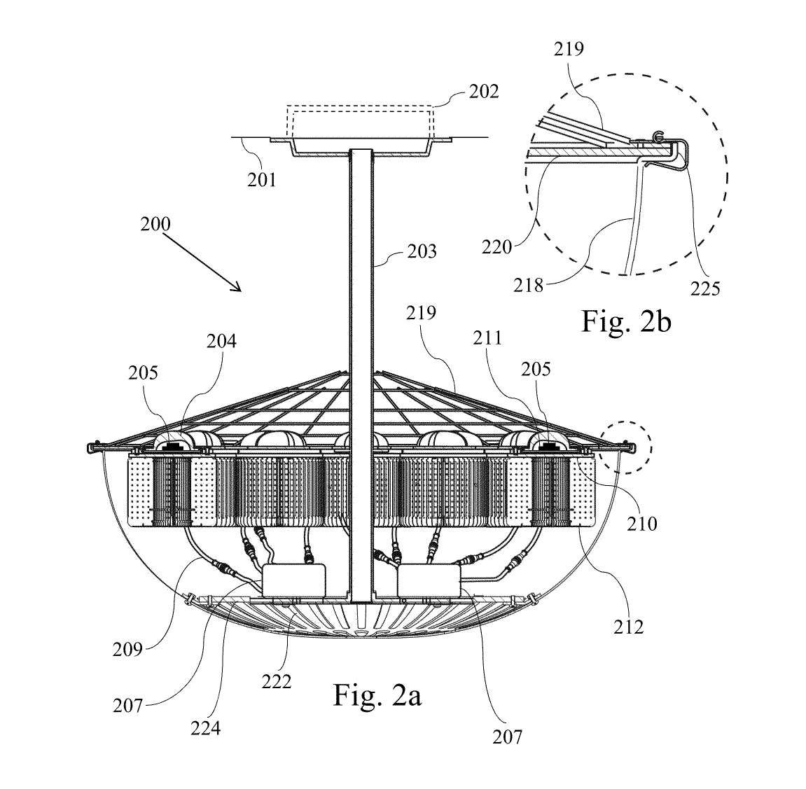

FIG. 2a and FIG. 2b show a cross-sectional view of a LED indirect light fixture 200 attached to a ceiling 201 at a junction box 202 by a stem 203. The stem 203 may be of any desired length (as will be described below) and carries electrical power from the junction box 202 to LED drivers 207. Electrical power wires are not shown. The electrical power is delivered to all eighteen LED light sources 205 (some not visible) from the LED drivers 207 via eighteen electrical cables 209 (some not visible), with one electrical two-conductor cable per LED light source 205. The LED light sources 205 are preferably “chip on board” (COB) type, similar to the Nimbus 5000 family of models of Lextar (www.lextar.com), with light output efficacies as high as 142 Lumens per Watt, Color Rendering Indexes (CRI) of 80, and Correlated Color Temperatures of 5000 K. The light sources 205 emit light, directed by lenses 204, at the ceiling 201. Heat sinks 212 and lenses 204 are assembled to a light engine plate 220. The light engine plate 220 has all lenses 204 assembled on its top surface, and has all heat sinks 212 assembled to its bottom surface. The plate 220 is assembled into a rim 225 of a fixture housing 218. The fixture housing 218 is equipped with air vents 222 for proper air ventilation and cooling of the heat sinks 212. The fixture housing 218 is attached to the stem 203 via a bracket plate 224. A wire guard 219 is assembled above the light engine plate 220 to prevent tennis ball deposits on the top of the lenses 204 and light engine plate 220. The light fixture 200 is made with eighteen LED light sources 205, with each light source 205 located within a space under the lens 204, and with respective base sides 211 attached to heat transfer plates 210 of heat sinks 212.

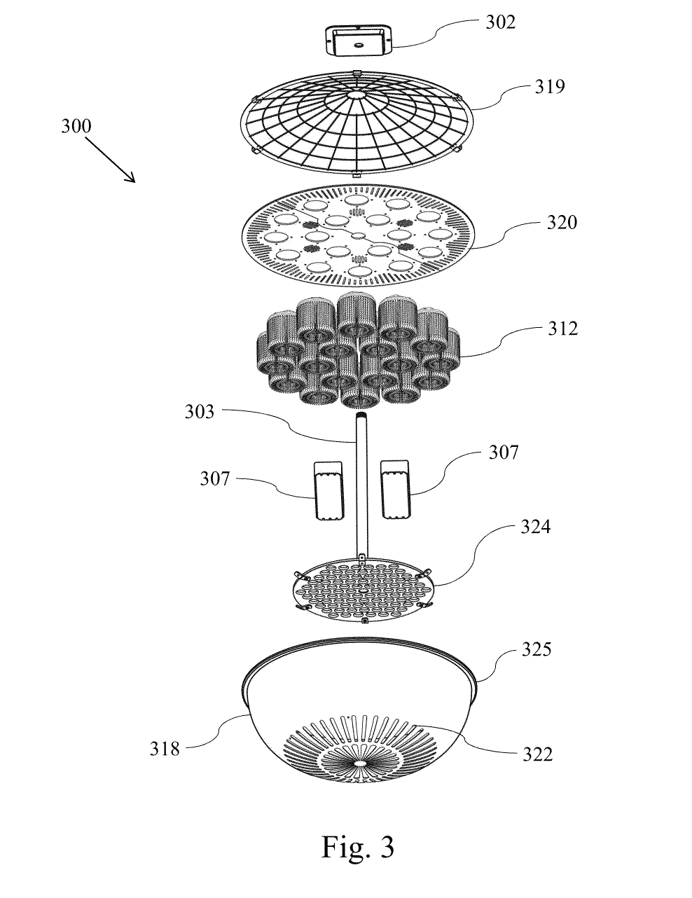

FIG. 3 shows a bottom exploded view of a LED indirect light fixture 300. The parts of the fixture 300 that are shown include a junction box 302, a wire guard 319, a light engine plate 320, heat sinks 312, a stem 303, drivers 307, a bracket plate 324, and a fixture housing 318 with rim 325 and vents 322.

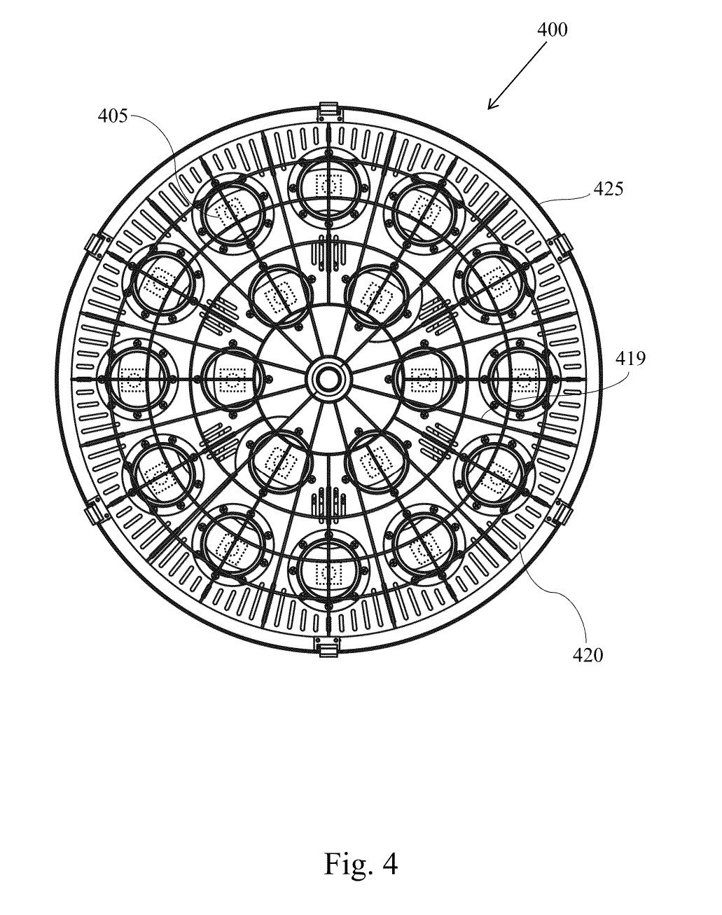

FIG. 4 shows a top side view of a LED indirect light fixture 400. The parts of the fixture 400 that are shown include a wire guard 419, a rim 425, light sources 405, and a light engine plate 420.

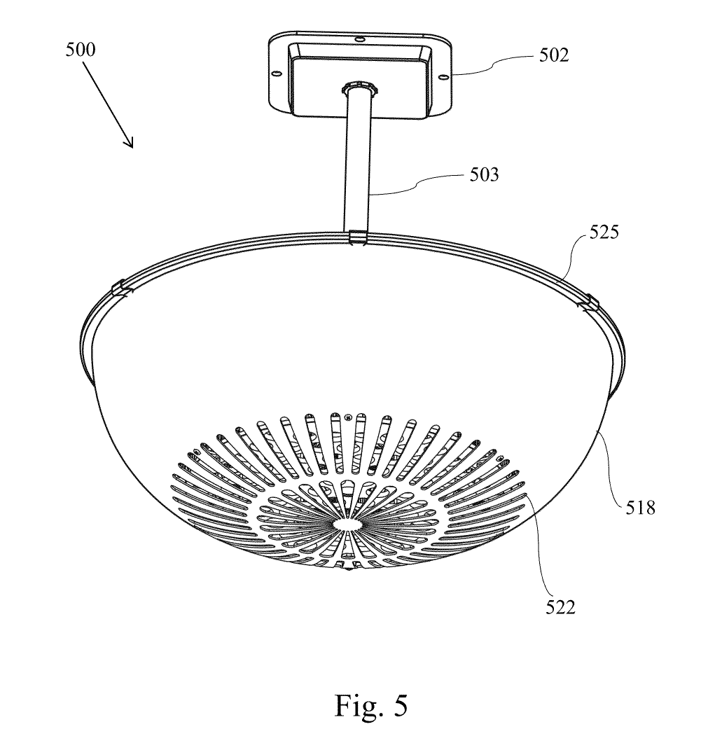

FIG. 5 shows a bottom perspective view of a LED indirect light fixture 500. A stem 503 is attached to a junction box 502. A fixture housing 518 is equipped with a rim 525 and vents 522.

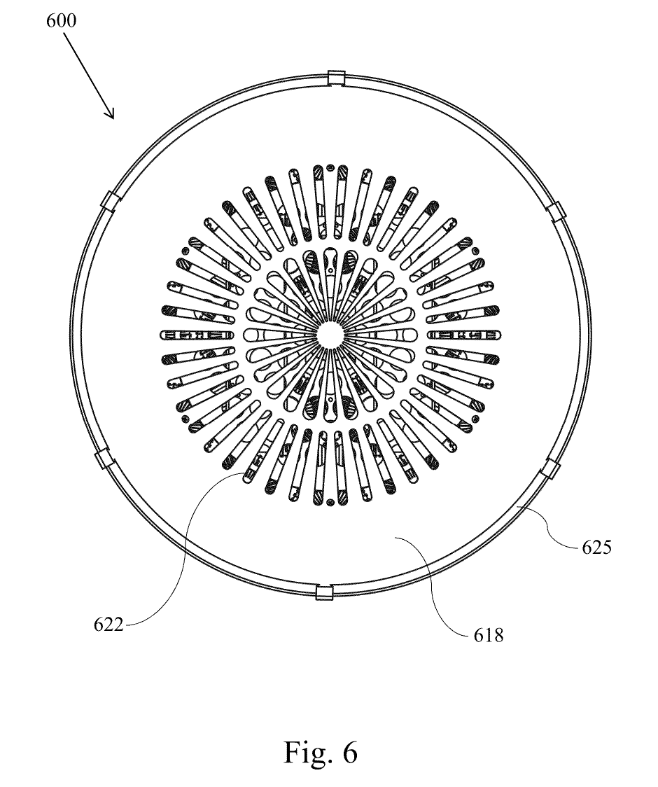

FIG. 6 shows a bottom view of a LED indirect light fixture 600. A fixture housing 618 is equipped with a rim 625 and vents 622.

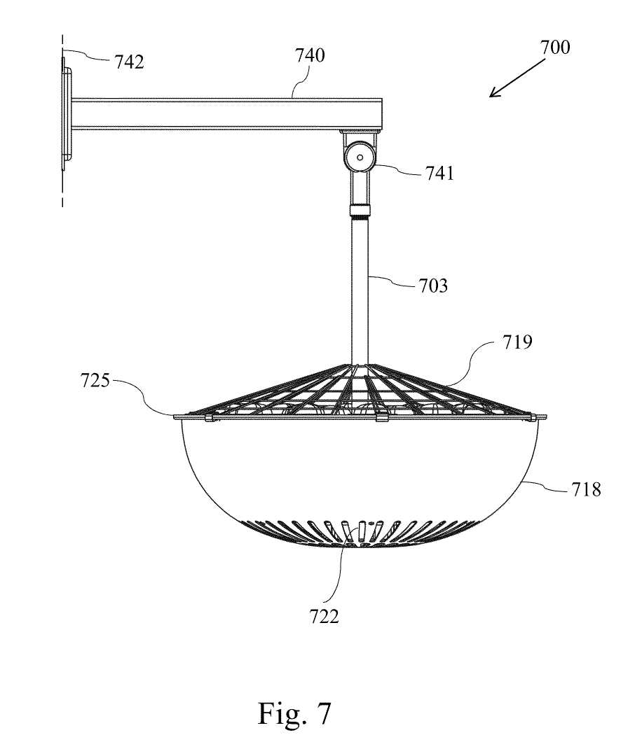

FIG. 7 shows a side view of a LED indirect light fixture 700 attached to a wall 742 with the use of a side arm 740. The side arm 740 is connected to a stem 703 with the use of a rotating pivot 741 to assure flexible hanging of a fixture housing 718 as directed by the earth's gravity. The fixture housing 718 is equipped with a rim 725 and vents 722. A wire guard is 719 is assembled into the rim 725 of the housing 718.

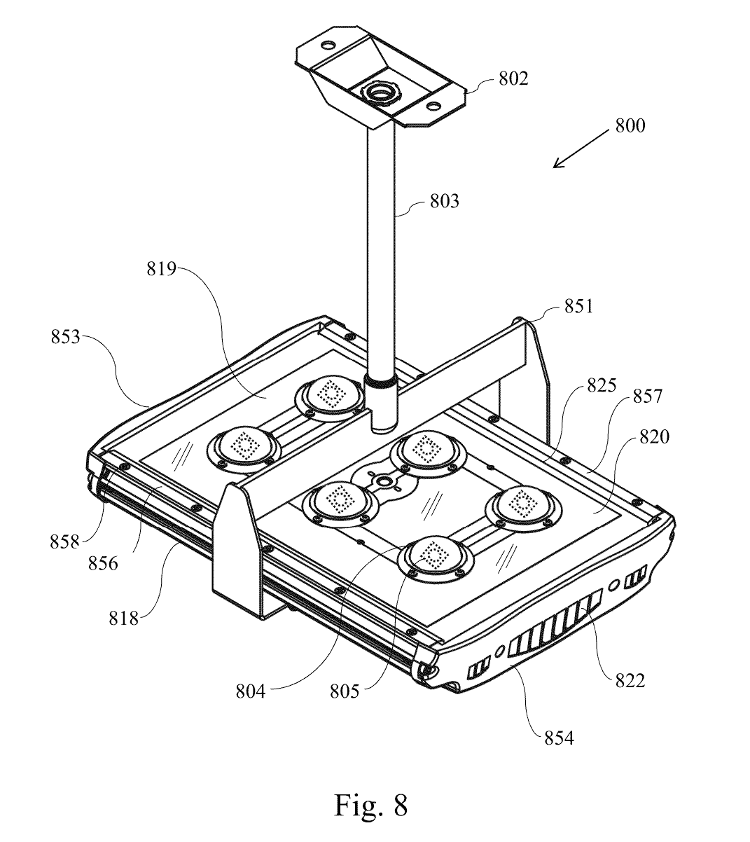

FIG. 8 shows a top perspective view of another embodiment of a LED indirect light fixture 800. The fixture 800 has a junction box 802 for attachment to a ceiling (not shown). A fixture housing 818 is hung to the ceiling with use of a stem 803 connected to the junction box 802. A cross-bar hanger 851 is attached to both the stem 803 and the body of the housing 818. The stem 803 may be of any desired length and carries electrical power from the junction box 802 to LED light sources 805 located within the lenses 804. Electrical wires are not shown. The electrical power is delivered to all six LED light sources 805. The LED light sources 805 are preferably “chip on board” (COB) type, similar to the Nimbus 5000 family of models of Lextar (www.lextar.com), with light output efficacies as high as 142 Lumens per Watt, Color Rendering Indexes (CRI) of 80, and Correlated Color Temperatures of 5000 K. The light sources 805 emit light, directed by the lenses 804, at the ceiling (not shown). The body of the light fixture housing 818 has a flat surface (not visible) that functions as a heat sink for the LED light sources 805 assembled on said flat surface. A light engine plate 820 is shown. Said light engine plate 820 has all lenses 804 assembled on its top surface, and a bottom surface of the light engine plate 820 is assembled to the flat surface of the fixture housing 818. The fixture housing has two end caps 853, 854 attached at the opposite ends of the fixture housing 818. Each end cap 853, 854 has vents 822 for proper cooling of the housing 818 and the LED light sources 805 mounted to the housing 818. The light engine plate 820 is fitted into the rectangular shape of a rim 825. Protective glass 819 is assembled above the light engine plate 820 and is fitted into the rim 825 with holding bars 856, 857 using screws 858.

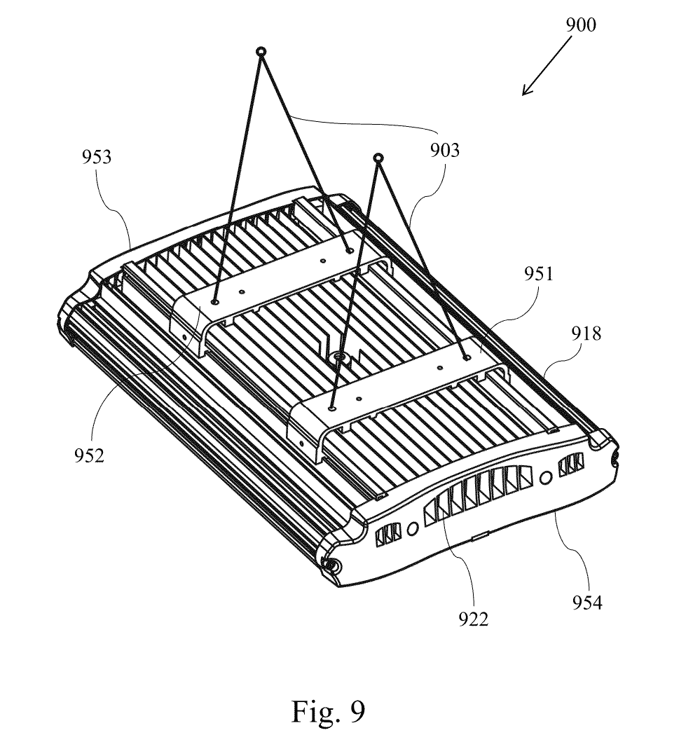

FIG. 9 shows a top perspective view of another embodiment of a LED light fixture 900 as a direct light fixture. The fixture 900 is the same in its main construction as the fixture shown in FIG. 8 and described earlier. The fixture 900, with use of a hanging system 903, is used as a LED direct lighting fixture with light directed directly at the floor of the facility or directly at any object desired to be illuminated. The hanging system 903 shown here is a wire type hanger and is attached to cross-bars 951, 952. The cross-bars 951, 952 are attached to a fixture housing 918. The fixture housing 918 has a flat surface (not visible) which also serves as a heat sink of LED light sources (not visible). The LED light sources are the same or of a similar type to those described in FIG. 8. End caps 953, 954 have vents 922 for proper cooling of the housing 918 and the LED light sources mounted to the housing 918.

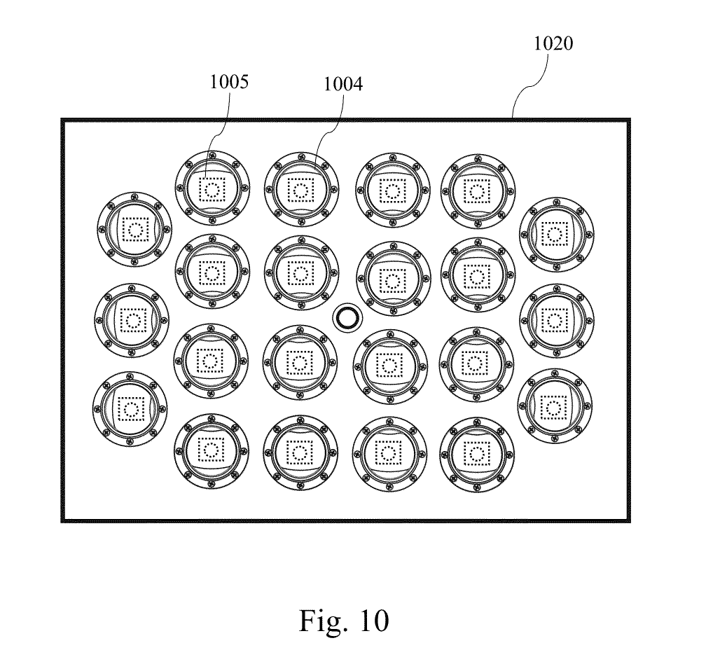

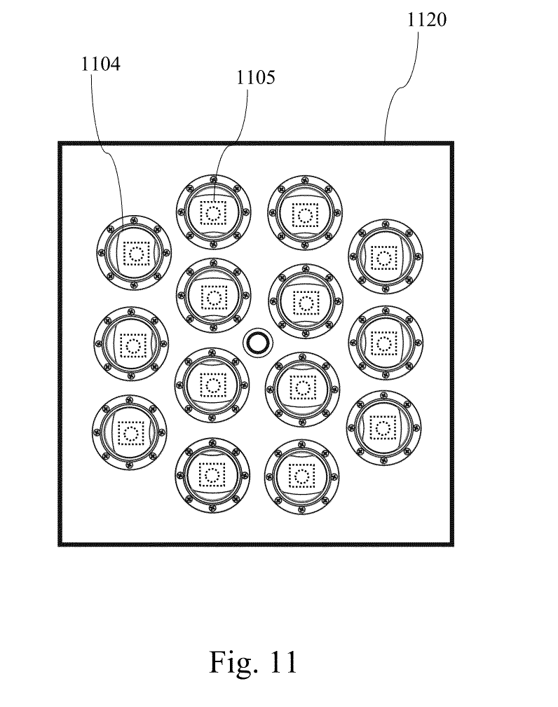

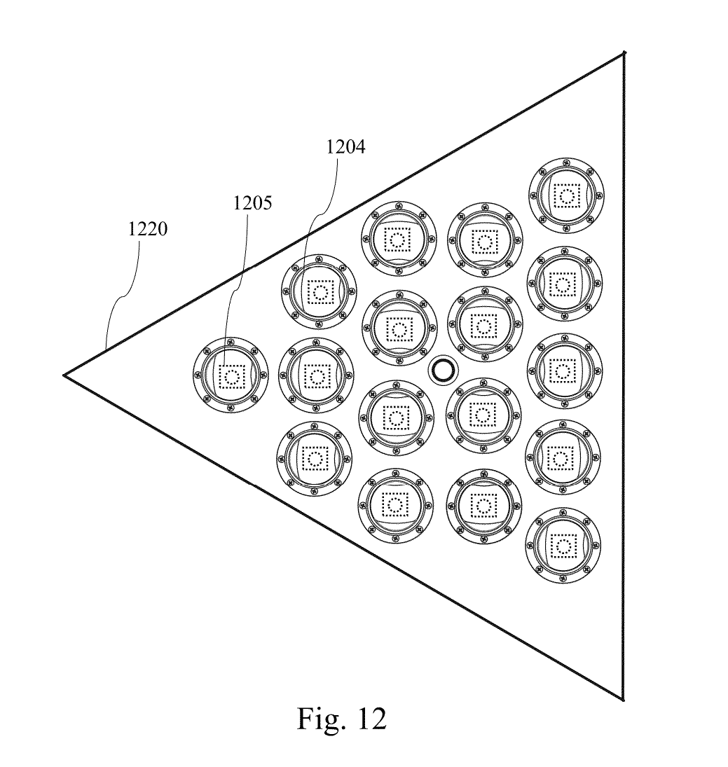

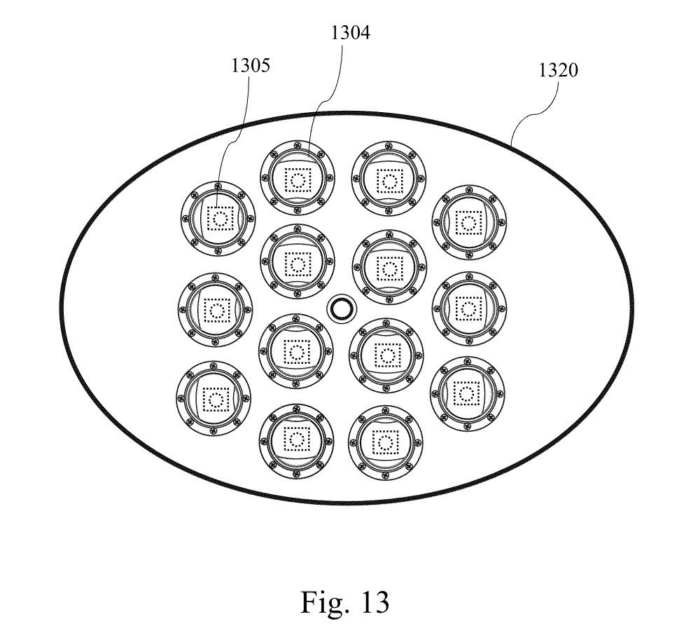

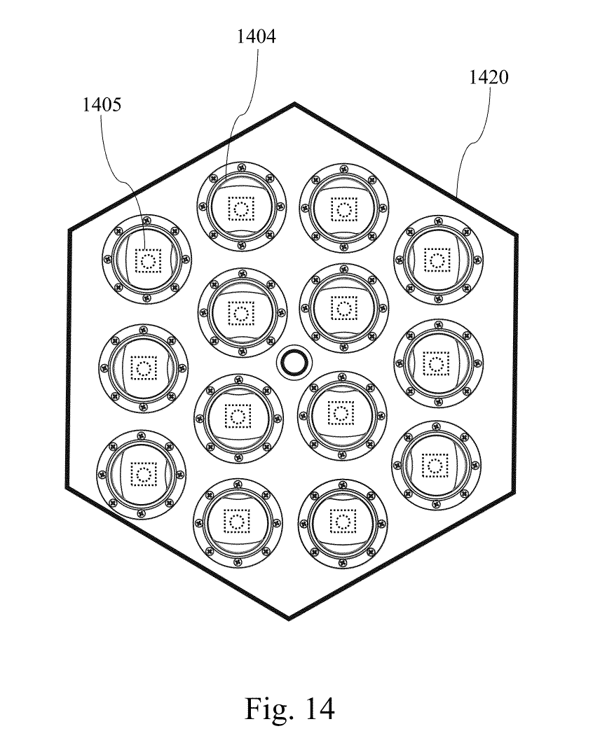

FIG. 10, FIG. 11, FIG. 12, FIG. 13, and FIG. 14 show top side views of various shapes of the light engines plates 1020, 1120, 1220, 1320 and 1420, respectively. The shapes of light engine plates 1020, 1120, 1220, 1320 and 1420 are “rectangle”, “square”, “triangle”, “oval”, or “hexagon,” respectively. The light engine plates 1020, 1120, 1220, 1320 and 1420 can be used in the construction of either indirect or direct LED light fixtures for illumination of surfaces or objects. Lenses 1004, 1104, 1204, 1304 and 1404 as well as light sources 1005, 1105, 1205, 1305, and 1405 are shown in FIG. 10, FIG. 11, FIG. 12, FIG. 13, and FIG. 14, respectively. It is understood by those skilled in the art that any shape of light engine plate can be created to fit into any desirable indirect or direct LED light fixture having any desirable housing shape, and with fixtures having either: (i) separate heat sink units attached to the light engine plate, or (ii) the fixture housing itself serving as a heat sink.

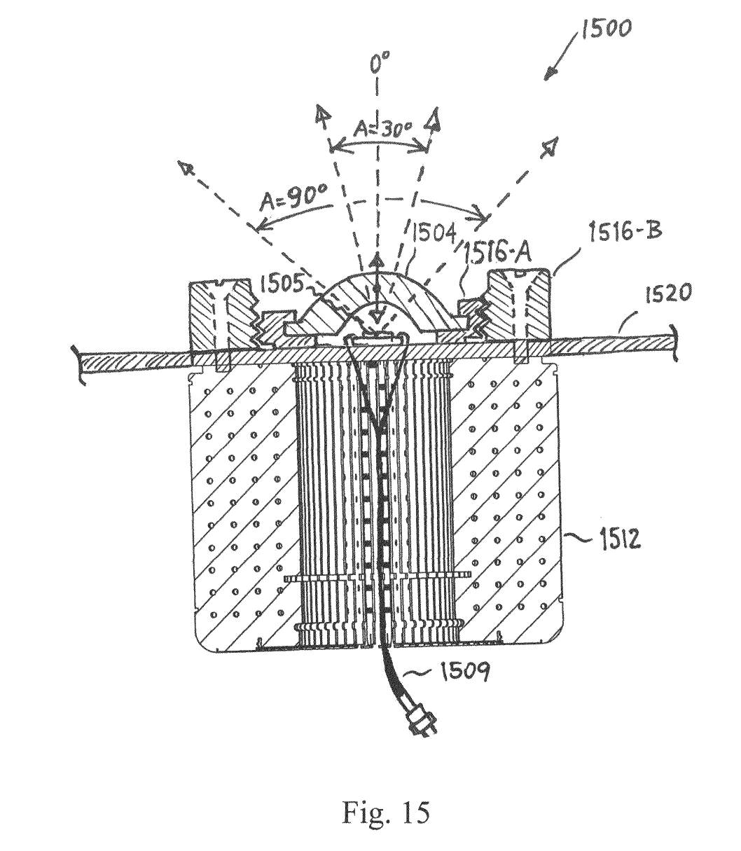

FIG. 15 shows a cross-sectional front side view of an adjustable beam angle light engine 1500 of a preferred embodiment of the invention. The LED light engine 1500 has a variable and adjustable beam angle “A” of light emitted. The beam angle “A” is adjustable from approximately 30 degrees to approximately 90 degrees. The adjustment is achieved through the use of a two-part threaded mechanism 1516-A, 1516-B employed to move a lens 1504 up and down in a vertical direction along the center axis 0 degrees. Whenever the lens is moved up and farther way from the light emitting side of the LED light source 1505, the beam angle “A” decreases. Whenever the lens is moved down and closer to the light emitting side of the LED light source 1505, the beam angle “A” increases. Also shown in FIG. 15 are a light engine plate 1520, a heat sink 1512, and a power supply cord 1509.

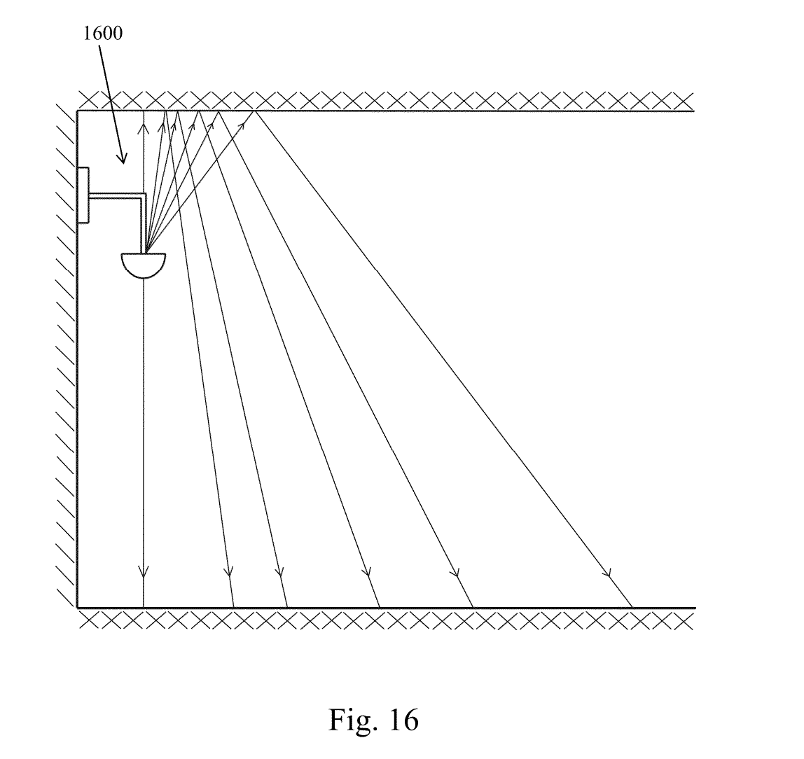

FIG. 16 shows a right side view of an asymmetrical beam pattern of one embodiment of the invention, wherein a LED indirect light fixture 1600 emits light in an asymmetrical fashion. The asymmetrical beam pattern is achieved through the use of asymmetrical lenses. Such light output is preferred in illumination of ceilings and floors by the wall-mounted indirect light fixture 1600.

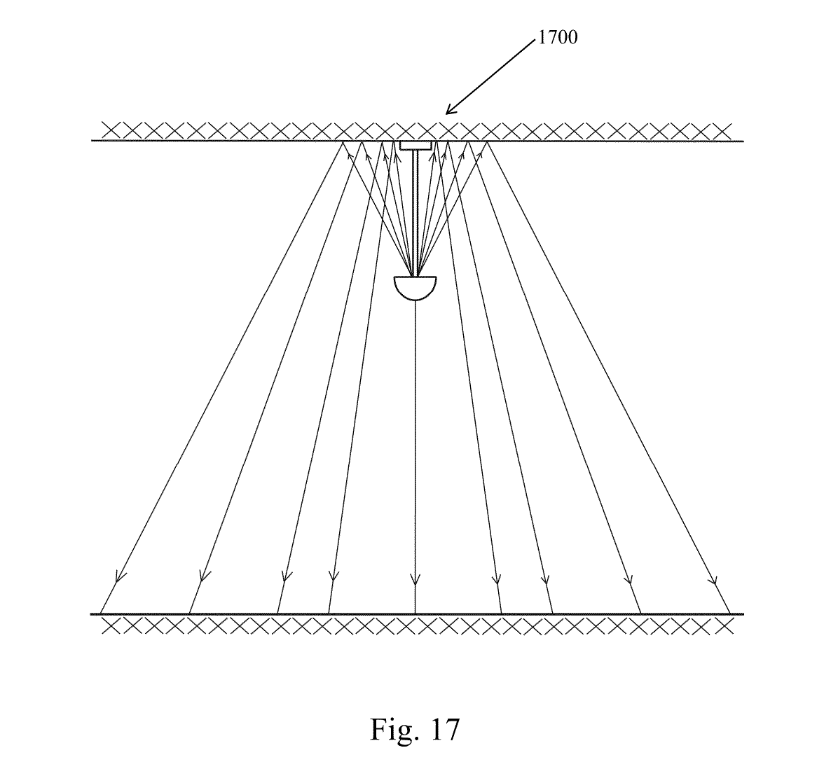

FIG. 17 shows a front side view of a symmetrical beam pattern of one embodiment of the invention, wherein a LED indirect light fixture 1700 emits light in a symmetrical fashion. The symmetrical beam pattern is achieved through the use of symmetrical lenses. Such light output is preferred in illumination of ceilings and floors by the ceiling-mounted indirect light fixture 1700.

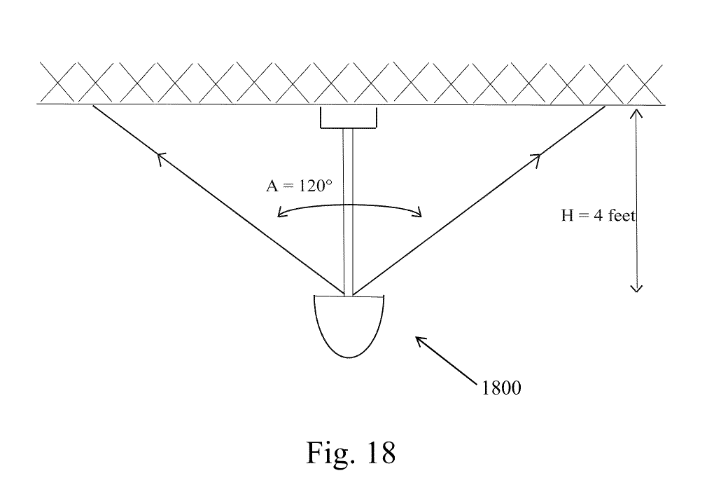

FIG. 18 shows an application of a preferred embodiment of the invention, wherein a LED indirect light fixture 1800 is mounted a relatively close distance from the ceiling. In this embodiment the distance is 4 feet. The fixture 1800 has symmetrical light output with a beam angle “A” equal to 120 degrees. The beam angle “A” is achieved through the use of symmetrical lenses. Such a beam angle is preferred in illumination of ceilings and floors by the LED indirect light fixture 1800 mounted a close distance from the ceiling.

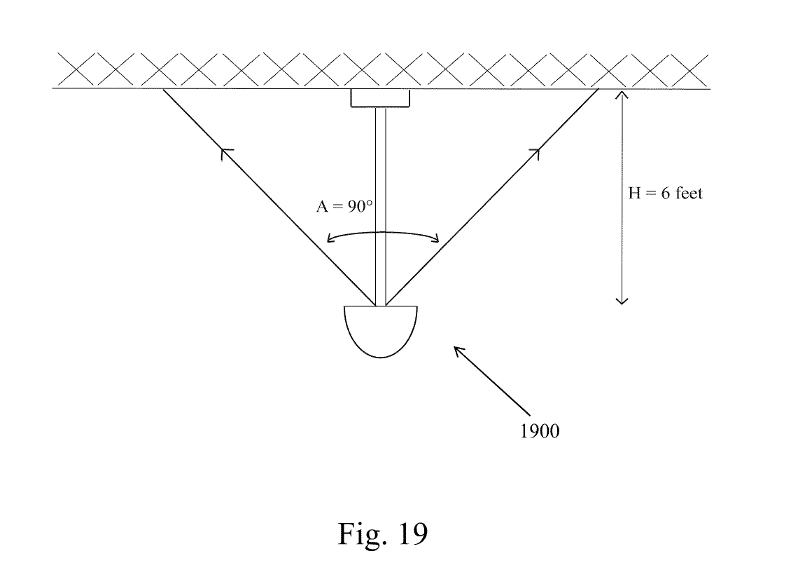

FIG. 19 shows another application of a preferred embodiment of the invention, wherein a LED indirect light fixture 1900 is mounted 6 feet from the ceiling. The fixture 1900 has symmetrical light output with a beam angle “A” equal to 90 degrees. The beam angle “A” is achieved through the use of symmetrical lenses. Such a beam angle is preferred in illumination of ceilings and floors by the LED indirect light fixture 1900 mounted approximately 6 feet from the ceiling.

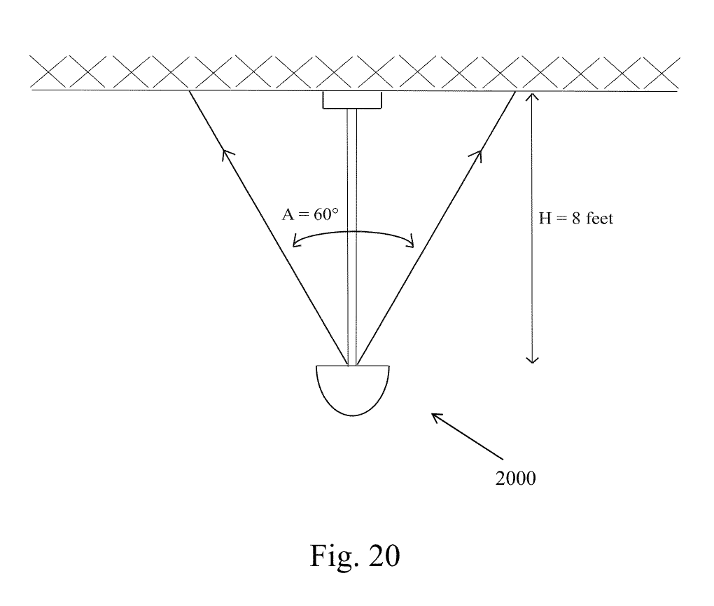

FIG. 20 shows another application of a preferred embodiment of the invention, wherein a LED indirect light fixture 2000 is mounted 8 feet from the ceiling. The fixture 2000 has symmetrical light output with a beam angle “A” equal to 60 degrees. The beam angle “A” is achieved through the use of symmetrical lenses. Such a beam angle is preferred in illumination of ceilings and floors by the LED indirect light fixture 2000 mounted approximately 8 feet from the ceiling.

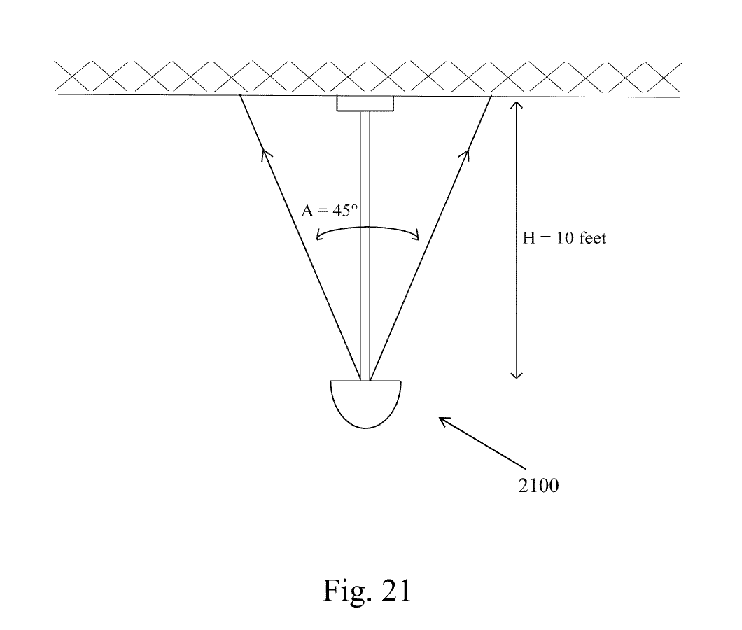

FIG. 21 shows another application of a preferred embodiment of the invention, wherein a LED indirect light fixture 2100 is mounted 10 feet from the ceiling. The fixture 2100 has symmetrical light output with a beam angle “A” equal to 45 degrees. The beam angle “A” is achieved through the use of symmetrical lenses. Such a beam angle is preferred in illumination of ceilings and floors by the LED indirect light fixture 2100 mounted approximately 10 feet from the ceiling.

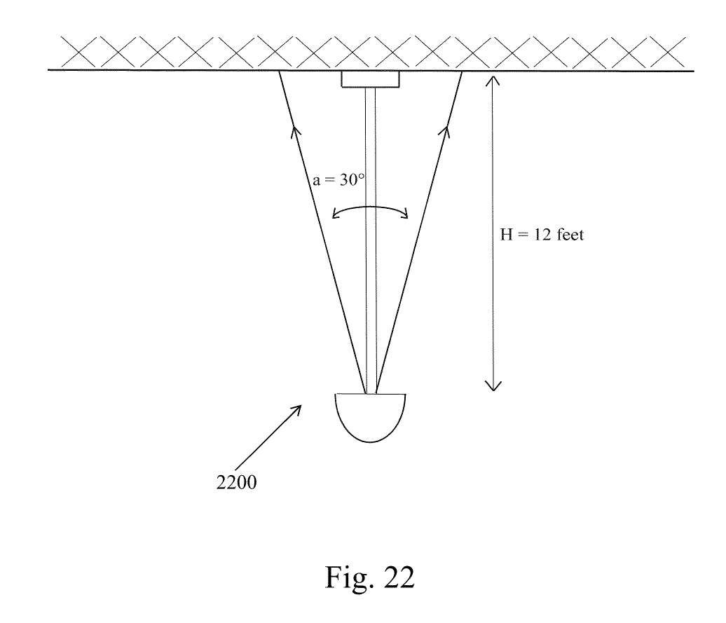

FIG. 22 shows another application of a preferred embodiment of the invention, wherein a LED indirect light fixture 2200 is mounted 12 feet from the ceiling. The fixture 2200 has symmetrical light output with a beam angle “A” equal to 30 degrees. The beam angle “A” is achieved through the use of symmetrical lenses. Such a beam angle is preferred in illumination of ceilings and floors by the LED indirect light fixture 2200 mounted approximately 12 feet from the ceiling.

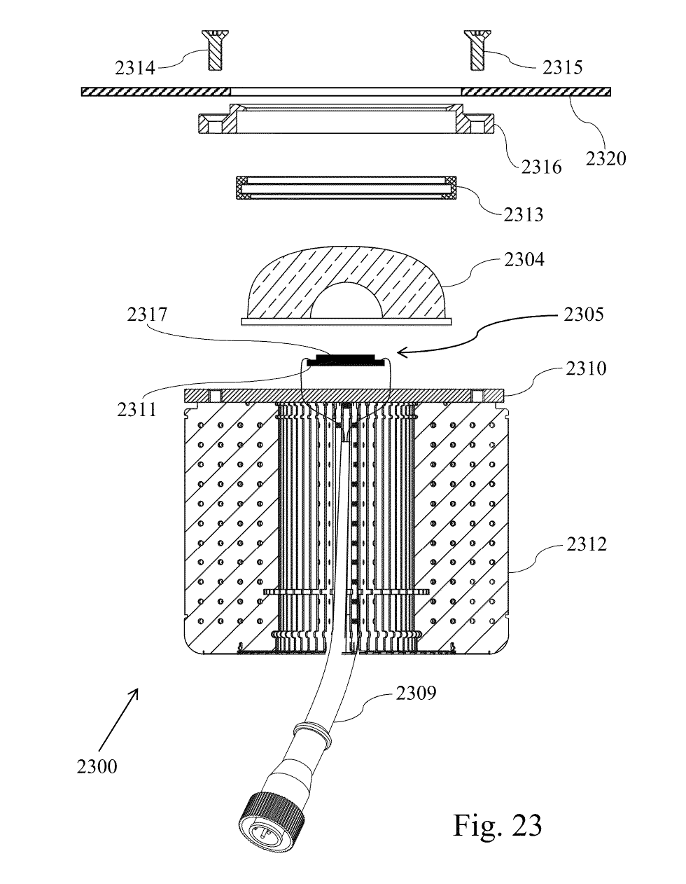

FIG. 23 shows an exploded cross-sectional front side view of a LED light engine 2300. The light engine 2300 has a heat sink 2312 with a power supply cord 2309 inserted and a heat transfer plate 2310 for assembly of a LED light source 2305 directly to said heat transfer plate 2310. The LED light source 2305 has a light emitting side 2317 and a base side 2311. The structure further includes a lens 2304 and a seal 2313. Additional components of the light engine 2300 are: a lens holder 2316, a light engine plate 2320, and assembly screws 2314, 2315.

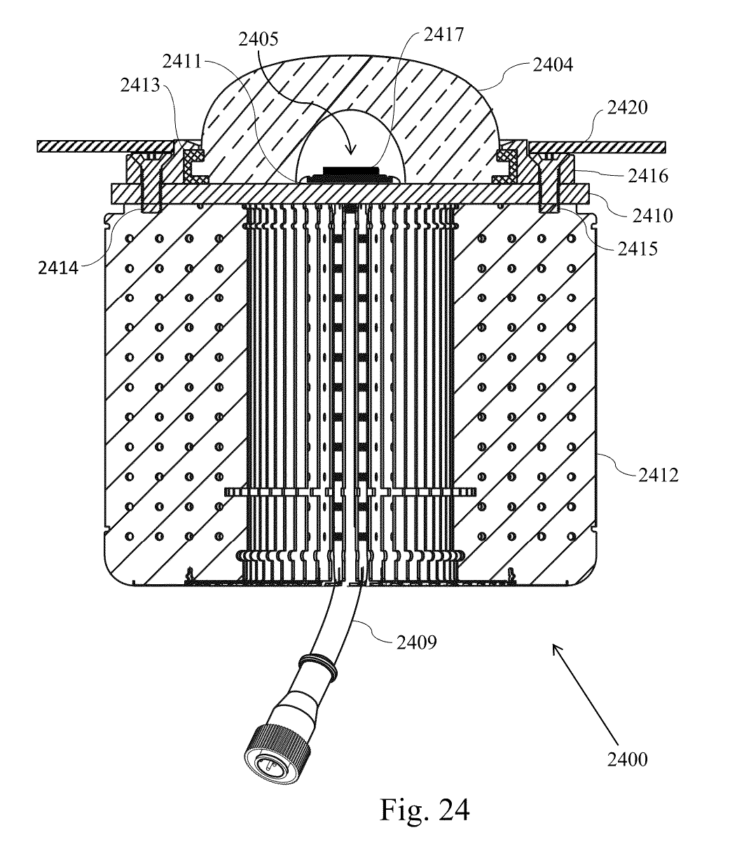

FIG. 24 shows a cross-sectional front side view of a LED light engine 2400. The light engine 2400 has a heat sink 2412 with a power supply cord 2409 inserted and a heat transfer plate 2410 for assembly of a LED light source 2405 directly to said heat transfer plate 2410. The LED light source 2405 has a light emitting side 2417 and a base side 2411. Additional components of the light engine 2400 are: a lens 2404, a seal 2413, a lens holder 2416, a light engine plate 2420, and assembly screws 2414, 2415.

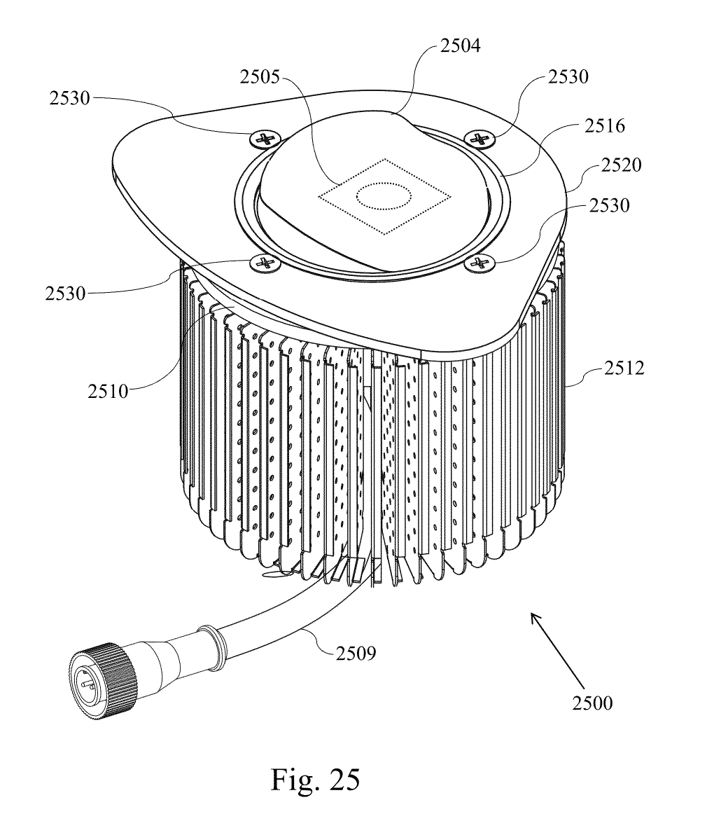

FIG. 25 shows an isometric view of a LED light engine 2500. The light engine 2500 has a heat sink 2512 with a power supply cord 2509 inserted and a heat transfer plate 2510 for assembly of a LED light source 2505. The LED light source 2505 is inside of the transparent lens 2504. The light engine 2500 further includes a light engine plate 2520 assembled to a seal holder 2516 and to the heat transfer plate 2510 of the heat sink 2512. Also shown are assembly screws 2530.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited. In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A LED indirect lighting fixture comprising:
a) an enclosure having an opening defined by an edge rim along a perimeter of said opening;
b) a LED light source having a light emitting side and a base side;
c) a light engine having a light engine plate fitted into the edge rim;
d) at least one integrated LED-lens module comprised of a transparent lens fitted over the light emitting side of the LED light source and a heat sink thermally coupled to the base side of the LED light source;
e) at least one LED-lens module is fitted in the opening of the enclosure; and
f) wherein light emitted from the LED-lens module is emitted directly outward from the opening of the enclosure.

2. The fixture of claim 1, wherein the light emitted from at least one LED-lens module has a symmetrical beam pattern defined by an output angle selected from the group consisting of 30 degrees, 45 degrees, 60 degrees, 90 degrees, and 120 degrees.

3. The fixture of claim 1, wherein the light emitted from the LED-lens module has a symmetrical beam pattern defined by an output angle ranging from 30 degrees to 150 degrees.

4. The fixture of claim 1, wherein the light emitted from the LED-lens module has an asymmetrical beam pattern defined by an output angle selected from the group consisting of 30 degrees, 45 degrees, 60 degrees, 90 degrees, and 120 degrees.

5. The fixture of claim 1, wherein the light emitted from the LED-lens module has an asymmetrical beam pattern defined by an output angle ranging from 30 degrees to 150 degrees.

6. The fixture of claim 1, wherein the lens is made of transparent glass or plastic material.

7. A LED lighting fixture comprising:
a) an enclosure having an opening defined by an edge rim along a perimeter of said opening;
b) a LED light source having a light emitting side and a base side;
c) a light engine having a light engine plate fitted into the edge rim;
d) at least one integrated LED-lens module comprised of a transparent lens fitted over the light emitting side of the LED light source and a heat sink thermally coupled to the base side of the LED light source;
e) at least one LED-lens module is fitted in the opening of the enclosure;
f) whereby the enclosure performs the function of a heat sink; and
g) wherein light emitted from the LED-lens module is emitted directly outward from the opening of the enclosure.

8. The fixture of claim 6, wherein the light emitted from at least one LED-lens module has a symmetrical beam pattern defined by an output angle selected from the group consisting of 30 degrees, 45 degrees, 60 degrees, 90 degrees, and 120 degrees.

9. The fixture of claim 6, wherein the light emitted from the LED-lens module has a symmetrical beam pattern defined by an output angle ranging from 30 degrees to 150 degrees.

10. The fixture of claim 6, wherein the light emitted from the LED-lens module has an asymmetrical beam pattern defined by an output angle selected from the group consisting of 30 degrees, 45 degrees, 60 degrees, 90 degrees, and 120 degrees.

11. The fixture of claim 6, wherein the light emitted from the LED-lens module has an asymmetrical beam pattern defined by an output angle ranging from 30 degrees to 150 degrees.

12. The fixture of claim 6, wherein the lens is made of transparent glass or plastic material.

13. A LED indirect lighting fixture comprising:
a) an enclosure having an opening defined by an edge rim along a perimeter of said opening;
b) a LED light source having a light emitting side and a base side;
c) a light engine having a light engine plate fitted into the edge rim;
d) at least one integrated LED-lens module comprised of a transparent lens fitted over the light emitting side of the LED light source and a heat sink thermally coupled to the base side of the LED light source;
e) at least one LED-lens module is fitted in the opening of the enclosure;
f) wherein light emitted from the LED-lens module is emitted directly outward from the opening of the enclosure with adjustable beam angle;
g) wherein the position of at least one lens of a LED-lens module is adjustable relative to the light emitting side of a LED light source; and
h) wherein the adjustable beam angle is a result of the adjustable position of at least one lens of the LED-lens module in relation to the position of the light emitting side of the LED light source.

14. The fixture of claim 11, wherein the light emitted from at least one LED-lens module has a symmetrical beam pattern defined by an output angle selected from the group consisting of 30 degrees, 45 degrees, 60 degrees, 90 degrees, and 120 degrees.

15. The fixture of claim 11, wherein the light emitted from the LED-lens module has a symmetrical beam pattern defined by an output angle ranging from 30 degrees to 150 degrees.

16. The fixture of claim 11, wherein the light emitted from the LED-lens module has an asymmetrical beam pattern defined by an output angle selected from the group consisting of 30 degrees, 45 degrees, 60 degrees, 90 degrees, and 120 degrees.

17. The fixture of claim 11, wherein the light emitted from the LED-lens module has an asymmetrical beam pattern defined by an output angle ranging from 30 degrees to 150 degrees.

18. The fixture of claim 11, wherein the lens is made of transparent glass or plastic material.

19. A fixture as in any of the preceding claims, wherein the enclosure opening has a shape selected from the group consisting of circle, rectangle, square, triangle, oval, and hexagon.
